(19) United States
(12) Patent Application Publication
(10) Pub. No.: US 2012/0186759 A1
(43) Pub. Date: Jul. 26, 2012

(54) Sunshade Assembly for a Side Window of a Vehicle

(76) Inventor: Paul Lin, Tainan City (TW)

(21) Appl. No.: 13/013,107

(22) Filed: Jan. 25, 2011

(51) Int. Cl. B60J 3/02

(52) U.S. Cl. 160/370.22

(57) ABSTRACT

A sunshade assembly includes a sunshade unit having a winding shaft, a sunshade cloth wound around the winding shaft, and a pull rod connected to one end of the sunshade cloth. A guide unit includes a tubular casing mounted below the housing and extending in a top-bottom direction, and a guide rod extending downward from the pull rod and slidable in the tubular casing. A positioning mechanism includes a locking unit, and a biasing unit for biasing the locking unit. When the sunshade cloth is moved from a wound position to a stretched position, the guide rod moves upward bringing along the pull rod until a bottom end of the guide rod reaches a top portion of the tubular casing, and the biasing unit biases the locking unit to lock the guide rod against movement relative to the tubular casing, thereby positioning the sunshade cloth in the stretched position.

### BACKGROUND OF THE INVENTION

1. Field of the Invention

The invention relates to a sunshade, and more particularly to a sunshade assembly that is adapted to be installed on a side window of a vehicle and that has a sunshade cloth which can be wound automatically.

2. Description of the Related Art

Referring to FIG. 1, a conventional sunshade assembly 1 includes a housing 11 mounted with a winding shaft 12, a sunshade cloth 13 wound around the winding shaft 12, and a pull rod 14 connected to one end of the sunshade cloth 13 and provided with a hook member 15. A hooking seat 16 is provided above the hook member 15. To use the conventional sunshade assembly 1, the pull rod 14 is pulled upward by a user to move the sunshade cloth 13 out of the housing 11, after which the hook member 15 is engaged to the hooking seat 16, thereby placing the sunshade cloth 13 in a stretched position.

However, use of the conventional sunshade assembly 1 is inconvenient because the hooking seat 16 must be accurately mounted at a position corresponding to that of the hook member 15 during assembly. Further, the conventional sunshade assembly makes use of the hook member 15 to engage the hooking seat 16 in order to position the sunshade cloth 13 at the stretched position

### SUMMARY OF THE INVENTION

Therefore, the object of the present invention is to provide a sunshade assembly that has a sunshade cloth which can be automatically positioned in a stretched position.

According to this invention, a sunshade assembly comprises a sunshade unit, a guide unit, and a positioning mechanism. The sunshade unit includes a housing, a winding shaft mounted rotatably in the housing, a sunshade cloth wound around the winding shaft, and a pull rod connected to one end of the sunshade cloth that is distal from the winding shaft and disposed externally to the housing. The guide unit includes a tubular casing mounted below the housing and extending in a top-bottom direction, and a guide rod extending downwardly from the pull rod and slidable in the tubular casing. The positioning mechanism includes at least one locking unit, and a biasing unit for biasing the locking unit. When the sunshade cloth is moved from a wound position to a stretched position, the guide rod moves upward bringing along the pull rod until a bottom end of the guide rod reaches a top portion of the tubular casing, and the biasing unit biases the locking unit to lock the guide rod against movement relative to the tubular casing, thereby positioning the sunshade cloth in the stretched position.

The advantages of the present invention reside in the fact that through the configuration of the positioning mechanism, when the sunshade unit is pulled manually to the stretched position, it can be positioned automatically. Hence, use of the present invention is relatively convenient.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional sunshade assembly;

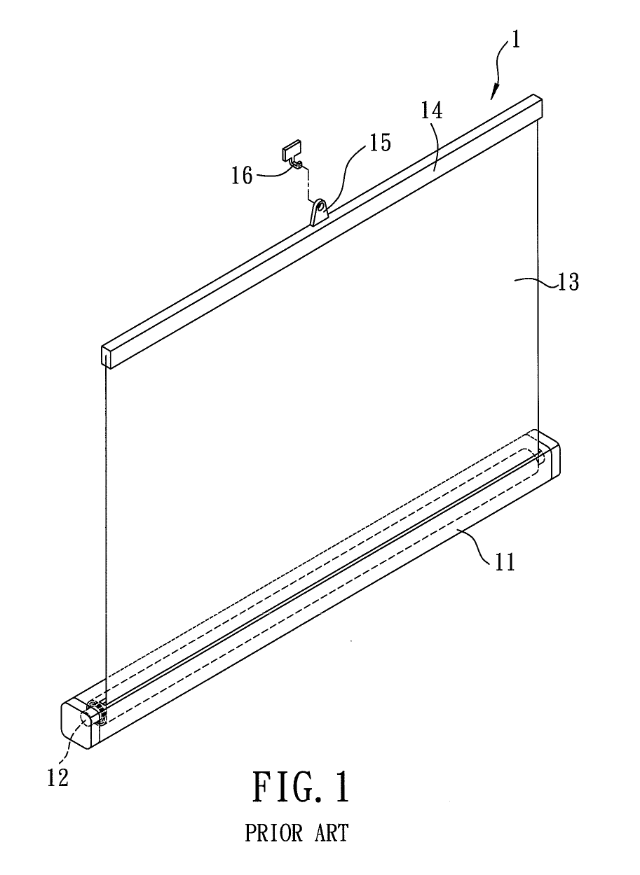

FIG. 2 is a partial sectional view of a sunshade assembly according to the first preferred embodiment of the present invention;

FIG. 3 is a fragmentary enlarged sectional view of FIG. 2, illustrating a guide rod being locked against movement relative to a tubular casing through locking units;

FIG. 4 is a view similar to FIG. 3, but illustrating the guide rod being movable along with a slide piece within the tubular casing;

FIG. 5 is a fragmentary perspective view of an alternative form of the first preferred embodiment;

FIG. 6 is a fragmentary enlarged sectional view of the alternative form of the first preferred embodiment;

FIG. 7 is a fragmentary enlarged sectional view of a sunshade assembly according to the second preferred embodiment of the present invention;

FIG. 8 is a view similar to FIG. 7, but illustrating a slide piece pushing rollers outward from a tubular casing; and

FIG. 9 is a view similar to FIG. 7, but illustrating the rollers being engaged to second locking grooves, respectively.

### DETAILED DESCRIPTION OF THE PREFERRED EMBODIMENTS

Before the present invention is described in greater detail, it should be noted that like elements are denoted by the same reference numerals throughout the disclosure.

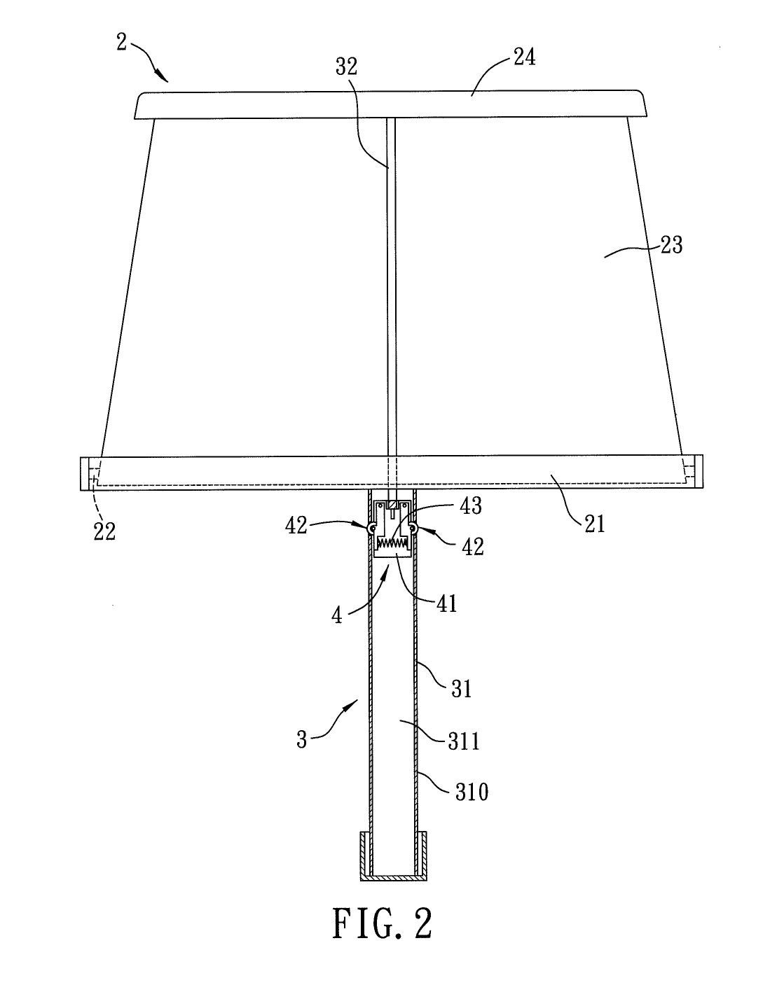

Referring to FIGS. 2 to 4, a sunshade assembly according to the first preferred embodiment of the present invention is adapted to be installed on a door (not shown) of a vehicle to cover a corresponding side window 5, and is shown to comprise a sunshade unit 2, a guide unit 3, and a positioning mechanism 4.

The sunshade unit 2 includes a housing 21 having a top opening (not shown), a winding shaft 22 mounted rotatably in the housing 21, a sunshade cloth 23 wound around the winding shaft 22, and a pull rod 24 connected to one end of the sunshade cloth 23 that is distal from the winding shaft 22 and disposed externally to the housing 21. The sunshade unit 2 may further include at least one biasing element (not shown) having one end that is fixed, and another end connected to the winding shaft 22. The biasing element is rotatable along with the winding shaft 22 to provide a winding biasing force to the winding shaft 22 along a winding direction. That is, in the absence of an external force, the sunshade cloth 23 is automatically wound into the housing 21 by the winding shaft 22.

The guide unit 3 includes a tubular casing 31 mounted below the housing 21 and extending in a top-bottom direction, and a guide rod 32 extending downward from the pull rod 24 and slidable in the tubular casing 31. The tubular casing 31 has a casing wall 310 defining a guide space 311 extending in a top-bottom direction to receive the guide rod 32.

A slide piece 41 is mounted fixedly to a bottom end of the guide rod 32, and is slidable upward and downward along with the guide rod 32 within the guide space 311.

The positioning mechanism 4 in this embodiment includes two locking units 42 disposed respectively on two opposite sides of the slide piece 41, and a biasing unit 43 for biasing the locking units 42. Two locking grooves 45 are formed in two opposite lateral sides of a top portion of the tubular casing 31. The two locking grooves 45 communicate spatially with the guide space 311. Each locking unit 42 includes a pivot arm 422 mounted rotatably to the slide piece 41, and a roller 423 mounted on the pivot arm 422 and in rollable contact with the casing wall 310. In use, as long as the locking unit can permit the slide piece 41 to be retained resiliently in the tubular casing 31, any structure of the locking unit 42 is acceptable. Hence, one or more locking units 42 may be used in variations of the preferred embodiment. The biasing unit 43, in this embodiment, includes a compression spring 431 disposed between the pivot arms 422 of the locking units 42. The compression spring 431 abuts against lower ends of the pivot arms 422 and biases the pivot arms 422 to push the rollers 423 into the respective locking grooves 45.

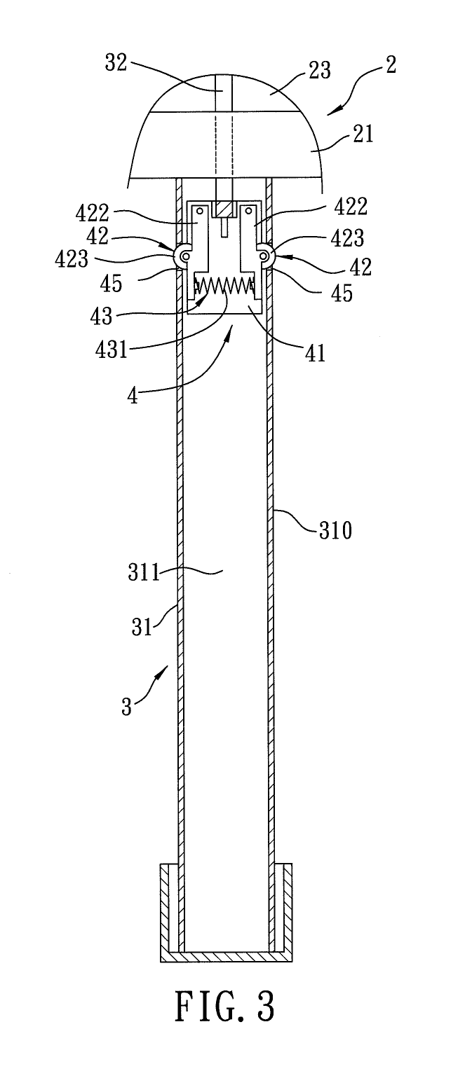

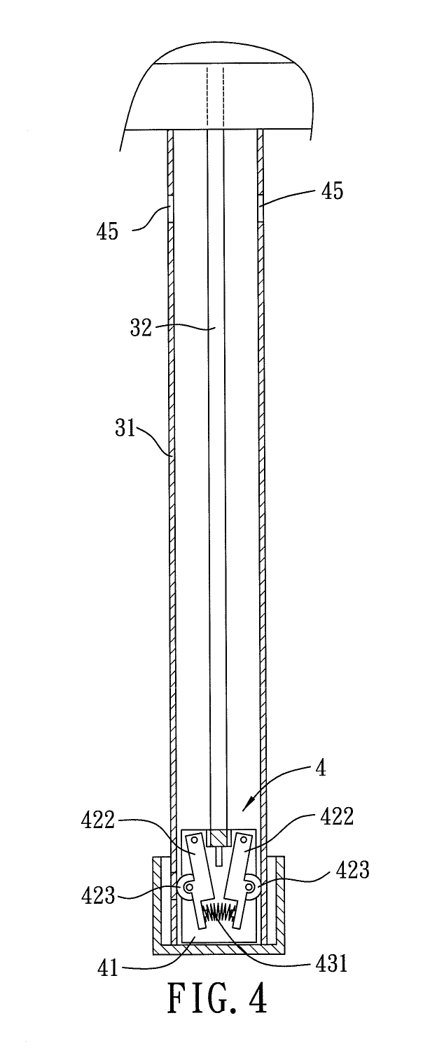

To use the sunshade cloth 23 to cover sunlight, the pull rod 24 is pulled upward by a user to move the sunshade cloth 23 from a wound position (see FIG. 4) to a stretched position externally to the housing 21, as shown in FIGS. 2 and 3. Simultaneously, the guide rod 32 moves upward along with the pull rod 24 until the bottom end of the guide rod 32 and the slide piece 41 reach the top portion of the tubular casing 31 and the position of the rollers 423 corresponds to the position of the locking grooves 45. At this time, the pivot arms 422 are biased by the compression spring 431 to push the rollers 423 into the respective locking grooves 45. Hence, the guide rod 32 is releasably locked against movement relative to the tubular casing 31 through the locking units 42, thereby positioning the sunshade cloth 23 at the stretched position.

To shift the sunshade cloth 23 from the stretched position shown in FIGS. 2 and 3 to the wound position shown in FIG. 4, the user can push the pull rod 24 downward to move the guide rod 32 and the slide piece 41 downward along the tubular casing 31, forcing the rollers 423 to move inward into the tubular casing 31 and out of the locking grooves 45. Simultaneously, the pivot arms 422 pivot toward each other and compress the compression spring 431 to store energy. At this time, the sunshade cloth 23 is wound by the winding shaft 22, and the guide rod 32 is brought to move downward until the sunshade cloth 23 moves to the wound position, as shown in FIG. 4. The sunshade assembly can further be mounted with a buffer unit (not shown) on a bottom portion of the tubular casing 31 to provide a buffer resistance to the downward movement of the guide rod 32 and to gradually reduce a winding speed of the sunshade cloth 23 until a full stop is reached.

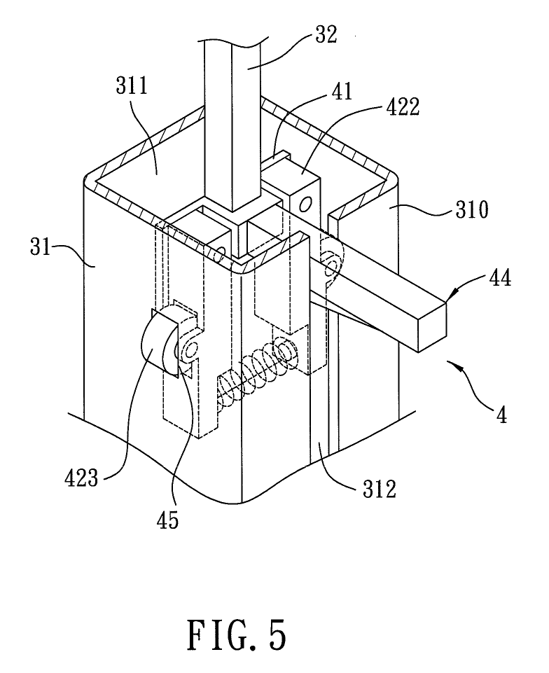

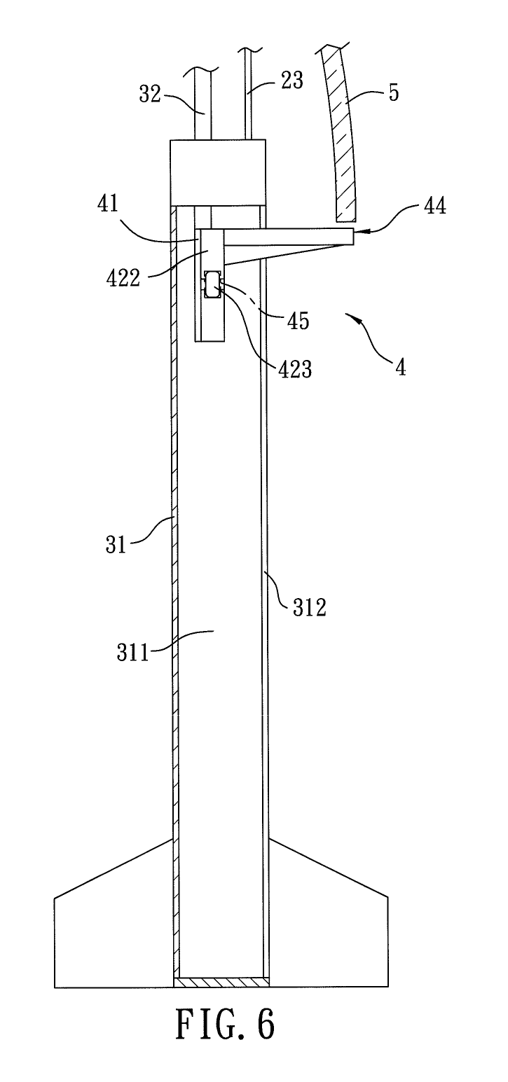

Further, with reference to FIGS. 2, 5, and 6, in an alternative embodiment, the present invention may make use of the side window 5 to automatically control winding of the sunshade cloth 23. In this case, the tubular casing 31 further includes a slot 312 formed in the casing wall 310, extending in a top-bottom direction, and communicating spatially with the guide space 311. The positioning mechanism 4 further includes a press member 44 mounted to the slide piece 41 and projecting outwardly of the casing wall 310 through the slot 312. The press member 44 is operable to move the slide piece 41 and the guide rod 32 downward. In a winding operation, when the side window 5 is slowly moved downward, it will contact and press downward the press member 44, which in turn, will move the slide piece 41 and the guide rod 32 downward along the tubular casing 31. At the same time, the rollers 423 are forced to move out of the respective locking grooves 45. As such, the winding shaft 22 (see FIG. 2) can wind the sunshade cloth 23 to the wound position. In actual practice, the press member 44 may be formed integrally as one piece with the slide piece 41 or screwed to the slide piece 41. Further, the press member 44 may be mounted adjustably to the slide piece 41 to coordinate with the downward position and timing of the side window 5. The press member 44 may also be mounted to the guide rod 32.

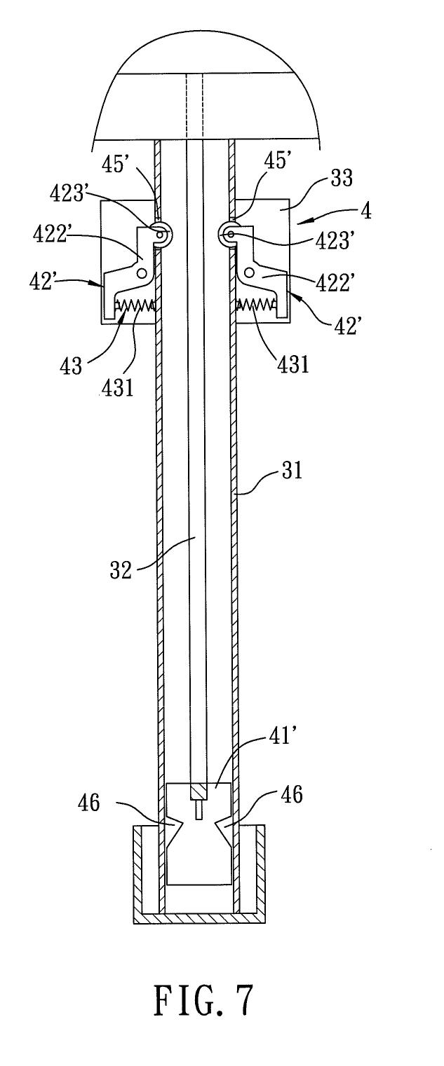

Referring to FIGS. 7 to 9, a sunshade assembly according to the second preferred embodiment of the present invention is shown to be similar to the first preferred embodiment. However, in this embodiment, the locking groove 45′ serves as a first locking groove, and the positioning mechanism 4 further includes a frame 33 disposed on an outer side of the top portion of the tubular casing 31, and a second locking groove 46 formed in the slide piece 41′ and alignable with the first locking groove 45′. Further, the two locking units 42′ are disposed-respectively on two opposite sides of the tubular casing 31. The central portions of the pivot arms 422′ of the locking units 42′ are connected pivotally to the frame 33, and the rollers 423′ are connected respectively to top ends of the pivot arms 422′ and are extendable into the tubular casing 31 through the respective first locking grooves 45′. The biasing unit 43 includes two compression springs 431 each disposed between one side of the tubular casing 31 and a bottom end of one of the pivot arms 422′. The compression springs 431 bias the pivot arms 422′ to move the rollers 423′ into the tubular casing 31 through the respective first locking grooves 45′.

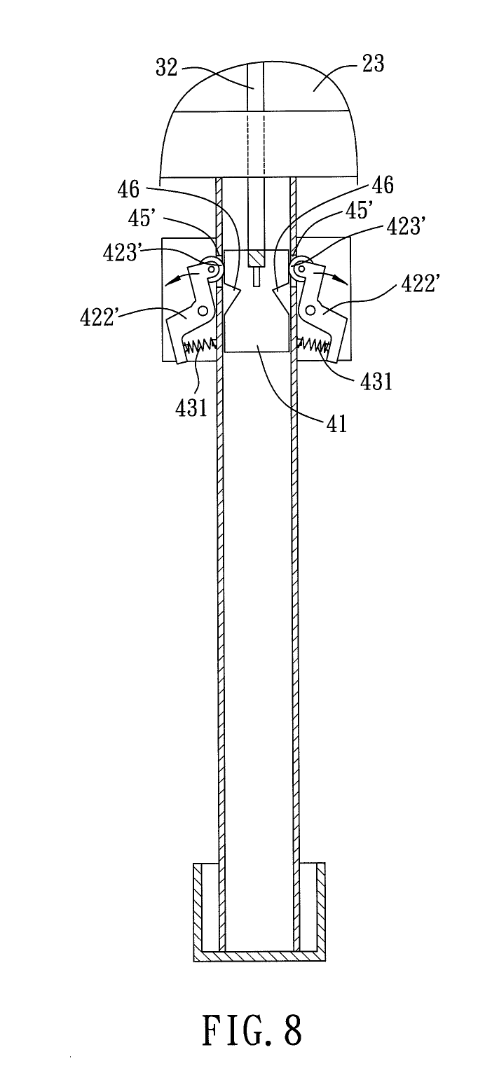

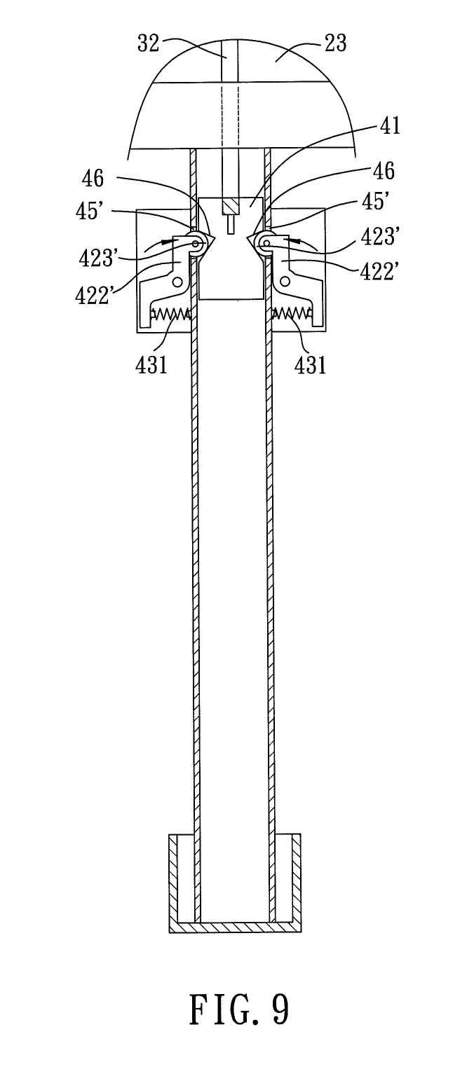

When the sunshade cloth 23 is moved from the wound position shown in FIG. 7 to a stretched position shown in FIG. 9, the sunshade cloth 23 moves the guide rod 32 and the slide piece 41′ upwardly therealong. When the slide piece 41′ reaches a position corresponding to the rollers 423′, as shown in FIG. 8, it will push the rollers 423′ outwardly of the tubular casing 31 so that the pivot arms 422′ also pivot outward, thereby compressing the compression springs 431 and permitting the slide piece 41′ to move past the rollers 423′. When the second locking grooves 46 are respectively aligned with the first locking grooves 45′, as shown in FIG. 9, the pivot arms 422′ are biased by the compression springs 431 to push the rollers 423′ to extend through the respective first locking grooves 45′ and to engage the respective second locking grooves 46, thereby positioning the sunshade cloth 23 in the stretched position.

In summary, the sunshade assembly of the present invention, through the configuration of the positioning mechanism 4, can have the sunshade cloth 23 positioned automatically when it is moved to the stretched position. Use of the present invention is thus very convenient, and the user is provided with an alternative choice.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A sunshade assembly comprising:
a sunshade unit including a housing, a winding shaft mounted rotatably in said housing, a sunshade cloth wound around said winding shaft, and a pull rod connected to one end of said sunshade cloth that is distal from said winding shaft and disposed externally to said housing;
a guide unit including a tubular casing mounted below said housing and extending in a top-bottom direction, and a guide rod extending downwardly from said pull rod and slidable in said tubular casing; and
a positioning mechanism including at least one locking unit, and a biasing unit for biasing said locking unit;
wherein, when said sunshade cloth is moved from a wound position to a stretched position, said guide rod moves upward bringing along said pull rod until a bottom end of said guide rod reaches a top portion of said tubular casing, and said biasing unit biases said locking unit to lock said guide rod against movement relative to said tubular casing, thereby positioning said sunshade cloth in said stretched position.

2. The sunshade assembly of claim 1, further comprising a slide piece mounted to the bottom end of said guide rod and slidable in said tubular casing.

3. The sunshade assembly of claim 2, wherein said positioning mechanism further includes a locking groove formed in the top portion of said tubular casing, said locking unit including a pivot arm mounted rotatably to said slide piece, and a roller mounted on said pivot arm and in rollable contact with said tubular casing, wherein, when said sunshade cloth is moved to said stretched position, said slide piece reaches said locking groove, and said pivot arm is biased by said biasing unit to push said roller into said locking groove.

4. The sunshade assembly of claim 3, wherein said positioning mechanism includes two said locking units disposed respectively on two opposite sides of said slide piece, said biasing unit including a compression spring disposed between said pivot arms of said locking units.

5. The sunshade assembly of claim 2, wherein said positioning mechanism further includes a frame disposed on an outer side of the top portion of said tubular casing, a first locking groove formed in the top portion of said tubular casing, and a second locking groove formed in said slide piece and alignable with said first locking groove, said locking unit having a pivot arm mounted rotatably on said frame, and a roller mounted on said pivot arm and extendable into said tubular casing through said first locking groove, wherein, when said sunshade cloth moves to said stretched position, said slide piece is moved so that said second locking groove is aligned with said first locking groove, and said pivot arm is biased by said biasing unit to push said roller to extend through said first locking groove and engage said second locking groove.

6. The sunshade assembly of claim 5, wherein said positioning mechanism includes two said locking units disposed respectively on two opposite sides of said tubular casing, said biasing unit including two compression springs each disposed between one side of said tubular casing and one of said pivot arms of said locking units.

7. The sunshade assembly of claim 2, wherein said tubular casing has a casing wall defining a guide space extending in a top-bottom direction to receive said guide rod, and a slot formed in said casing wall and extending in the top-bottom direction, said positioning mechanism further including a press member mounted to said slide piece and projecting outward from said casing wall through said slot, said press member being operable to move said slide piece and said guide rod downward.

8. The sunshade assembly of claim 2, wherein said positioning mechanism further includes a locking groove disposed on one of said tubular casing and said slide piece, said locking unit having a pivot arm mounted pivotally on the other one of said tubular casing and said slide piece, said pivot arm being biased by said biasing unit to engage said locking groove when said slide piece slides to atop portion of said tubular casing.

9. The sunshade assembly of claim 8, wherein said locking unit further has a roller attached to and projecting from said pivot arm, said roller extending into said locking groove when said slide piece reaches the top portion of said tubular casing.
